(19) United States
(12) Patent Application Publication
(10) Pub. No.: US 2005/0191506 A1
(43) Pub. Date: Sep. 1, 2005

(54) Rubber and wood composite sheet

(76) Inventors: Niranjan Thakore, Toronto (CA); Zhigang Yin, Toronto (CA); Andrew Haber, Oakville (CA); Andrew Pattenden, Aurora (CA)

Correspondence Address: LADAS & PARRY LLP, 224 SOUTH MICHIGAN AVENUE, SUITE 1600, CHICAGO, IL, 60604, US

(21) Appl. No.: 10/787,498

(22) Filed: Feb. 26, 2004

(51) Int. Cl. B32B 21/04

(52) U.S. Cl. 428/496; 428/537.1

(57) ABSTRACT

A wood and rubber composite sheet comprises a wood layer, preferably plywood, having a first surface and a layer of cured masticated rubber secured to said first surface. An adhesive material, such as Chemlock™ is disposed between said first surface and said rubber layer. A method of manufacturing the composite plywood and masticated rubber sheet comprises the steps of: providing a layer of wood having an outer surface; providing a layer of uncured masticated rubber upon said outer surface; heating and pressing said layers together so as to cure and bond said rubber layer to said outer surface of wood. An adhesive material may be disposed between the rubber layer and outer surface prior to heating and pressing.

### FIELD OF THE INVENTION

The present invention relates to a composite sheet comprising at least one layer of rubber and at least one layer of wood and a method of manufacturing same.

### BACKGROUND OF THE INVENTION

It is known to combine layers of rubber and wood to form a wood and rubber laminate. For example, UK Patent Specification No. 225,251 discloses a composite sheet comprising a layer of rubber faced on one or each side with a layer of wood firmly bonded with the layer of rubber. The method for producing the sheet involves combining raw or crude rubber with a layer or layers or wood, previously moistened with liquid, such as oil or water, placing same in a vulcanizing press, vulcanizing at temperature of 245° Fahrenheit under considerable pressure sheet after which the sheet is immersed in water or oil.

U.K Patent Specification No. 1435195 discloses a method of manufacturing a laminate sheet, wherein a wood veneer is covered on one side with a layer of polymer which is bonded to the veneer by heating under pressure. The polymer may be natural rubber or synthetic rubber or a mixture thereof. The wood veneer may be formed of wood, or wood powder or wood shavings glued together by means of a synthetic resin. Forming the laminate as disclosed in UK Specification 1435195 involves at least two distinct process steps, namely firstly bonding the layer of polymer to the layer of the wood veneer and secondly, bonding the veneer by gluing on its uncoated side to a wood substrate, such a multi-plywood, multi-ply fibreboard or chip board.

European Published Patent Application No. 0411452A2 discloses a combination of a layer of marine plywood and a layer of a synthetic rubber, said layers being joined together by means of an adhesive of a structural type.

It is also known to provide flooring which includes a rubber layer and a wood layer. Typically, however, these layers are provided separately, with the rubber layer being disposed adjacent to but not secured to the wood layer, thereby creating the need to align and lay each layer on top of each other.

The utilization of recycled tire scrap rubber, in various industrial applications is highly desirable, yet utilization of same in certain applications in an efficient and effective manner remains somewhat elusive. Nothing in the prior art discloses the use of post industrial and/or post consumer rubber (often referred to as “masticated rubber”) in a rubber wood composite sheet in an efficient and effective manner.

### SUMMARY OF THE INVENTION

It is an object of the present invention to overcome, inter alia, the shortcomings of the prior art described above by providing an improved rubber and wood composite sheet.

In accordance with an aspect of the invention there is provided a wood and rubber composite sheet comprising a wood layer having a first surface and a layer of cured masticated rubber attached to said first surface.

In accordance with a further aspect of the invention there is provided a method of manufacturing a composite wood and rubber sheet comprising the steps of;
(a) providing a layer of wood having an outer surface;
(b) providing a layer of uncured masticated rubber upon said outer surface,
(c) heating and pressing said layers together so as to cure and bond said rubber layer to said outer surface of wood.

Other advantages, features and characteristics of the present invention, as well as methods of operation and functions and economies of manufacture, will become more apparent upon consideration of the following detailed description and the appended claims.

### DESCRIPTION OF EXAMPLE EMBODIMENTS OF THE INVENTION

The product in accordance with an aspect of the invention comprises a composite sheet having a layer of cured masticated rubber adhered to an outer surface of a wood layer. The wood layer is preferably a sheet of standard 5/8th inch thick five ply plywood, typically coming in sheets of 4 feet by 8 feet or 4 feet by 4 feet. It should be understood, that other wood forms, such as solid wood sheets, particle boards or the like, could be utilized as the wood layer of the invention.

The rubber utilized in accordance with this invention is masticated rubber. Prior to attachment to the wood layer, the rubber layer may come in cured or in uncured form. Masticated rubber is a blend of uncured friction cord (generally a natural rubber (NR)/styrene butadiene rubber (SBR) compound calendared onto tire belting) waste from tire manufacturers, uncured NR/SBR compound waste from rubber processors including tire manufacturers, ground up vulcanized tire rubber and fiber from recycled scrap tires, various ground rubber and fiber materials from internally generated waste and typical rubber processing and vulcanizing ingredients. A preferred version of masticated rubber comprises a thermoset rubber blend based on tire belt, tread and sidewall compounds in both cured and uncured form that also contains fiber strands originating from original tire manufacturing, homogeneously dispersed throughout the blend. Additional fabric strands from other sources can also be incorporated to further increase stiffness and tensile strength. The fiber, blended into the masticated rubber mixtures increases stiffness adds strength, increases the modulus and overall hardness of the final product and reduces elongation or stretching of the rubber product. The fibers utilized are typically a mixture of short and long fibers comprised of polyester or nylon or other synthetic polymers. An example of masticated rubber used in accordance with the invention to be cured and bonded to the wood layer is Symar® rubber available from the applicant, NRI Technology Inc., Toronto, Canada.

Preferably, an adhesive material is disposed between the masticated rubber layer and the wood layer. Suitable adhesives are thermosetting types which cure or harden by the action of heat or catalyst. The preferred adhesive material utilized with the invention, disposed between the rubber layer and the wood layer is Chemlock™ or Thixon™. It should be understood that any suitable adhesive which reacts during the heating and pressing process to bond the rubber to the wood layer may be utilized.

Advantageously, the heat and pressure conditions utilized to cure masticated rubber sheets may be used to form the masticated rubber and wood laminate. In a preferred process in accordance with the invention, uncured masticated rubber is placed on the outer surface of the outer ply of a standard multiple plywood sheet. The rubber layer is then simultaneously cured and bonded to the wood layer. The rubber layer may then be adhered to one side or both sides of the plywood using heat and pressure. Examples of how the rubber layer may be adhered are: (i) by means of a compression molding process, (ii) by means of a continuous cure process.

(i) Compression Molding Process: In an example of a method of forming a composite sheet in accordance with the invention, a standard compression press machine may be utilized to form the composite sheet of masticated rubber and wood as follows. The wood, preferably comprising sheets of plywood, typically 4 foot by 8 foot planks of 518 inch thick 5 ply plywood is inserted into a compression press machine. Prior to placing an uncured masticated rubber sheet on top of the plywood layer, the outer surface of the plywood is treated with an elastomer bonding adhesive such as Chemlock™ or Thixon™. Once treated with said adhesive, the uncured masticated rubber sheet is placed on top of the adhesively treated surface and the whole assembly of wood plywood sheets the rubber and wood layers are heated and pressed together. Preferably the rubber sheet is pressed to a thickness of approximately 0.1 inches, although the rubber thickness could vary within the range of 0.06 inches to 0.5 inches if desired. To achieve the best results of adherence of the masticated rubber to plywood in an even manner, the preferred pressure applied to the composite would be in the range of 200 psi to 400 psi and the preferred temperature would be between 300 and 345 F. The preferred duration of application of this heat and pressure is between 5 minutes and 20 minutes. The rubber wood composite product would be allowed to cool and would have excess rubber trimmed as it exits the press. As desired, a rubber laminate having a thickness outside of these ranges could be utilized.

(ii) Continuous cure process: The masticated rubber layer and the wood layer may be adhered together using a continuous curing process. The continuous curing process involves an apparatus including conveyor means which advances the rubber and wood through the apparatus, a heat source and a pressure source which are simultaneously applied to the rubber and wood as they are advanced through the apparatus, thereby curing and bonding the masticated rubber layer to the wood. The preferred conveyor means comprises upper and lower stainless steel belts, between which are carried the wood and masticated rubber layers. In an example of the continuous curing process, a plank of wood, such as a standard 4 foot by 8 foot, 5 ply, 5/8 inch plywood plank, is positioned horizontally at an entry position to the machine upon the lower belt. An adhesive, such as Chemlock™ is applied to the top surface of the plywood. A roll of uncured masticated rubber is placed adjacent the entry position. A sufficient amount of rubber sheet to cover the wood layer is dispensed from the roll, and is placed over the upper surface of the wood layer now having the layer of Chemlock™ applied to its upper surface. The combined rubber and plywood layer are advanced by the moving belts through the press machine. As the rubber and wood layers are carried between the upper and lower belts, through the continuous press, heat (in the range of 300° to 350° F.) is applied to the rubber and wood layers. In combination with the heat applied, the lower belt moves the rubber and wood layers along the machine, and the layers are sandwiched between the upper and lower belts, pressing the rubber to the desired thickness on the wood layer, causing the rubber to be cured and bonded to the plywood layer. To achieve the best results of adherence of rubber to plywood in an even manner, the preferred pressure applied to the rubber and wood layer composite would be 200 to 400 psi. Once heated and pressed to the desired thickness, the cured masticated rubber and wood sheet continues to an exit position where it is allowed to cool and excess rubber is trimmed and the cured masticated rubber wood composite board is stacked. As with the compression molding process, preferably the rubber sheet is pressed to a thickness of approximately 0.1 inches, although the rubber thickness could vary within the range of 0.060 inches to 0.5 inches if desired.

Preferably, heat is applied by circulating steam or hot oil through the upper and lower platens of the press. Preferably, hydraulic pressure is applied by means of a hydraulic unit in combination with a plurality of hydraulic cylinders arranged structurally to apply an even force distribution across the width of the platens. This force distribution acts to press the upper and lower platens of the press together within a specific pressure range, as dictated by the product. The pressing time may vary anywhere from 4 to 12 minutes depending on the desired thickness of the rubber, typically, the thicker the rubber layer, the longer the pressing time.

Preferably the pressing machine has open sides between the upper and lower belts, which allows moisture out of plywood during heating and pressing of the rubber layer to the plywood. This provides an advantage for certain grades of plywood, such as lower grade retail plywood which tends to accumulate moisture during storage.

It should be understood that although the outer surface of the plywood is preferably treated with a heat activated adhesive such as Chemlock™ or Thixon™, it is possible to adhere the rubber layer to the plywood without the use of an intermediate adhesive, by simply applying heat and pressure thereto, under the conditions described above. It should be further understood that a layer of cured masticated rubber may be adhered to one or more surfaces of the wood layer.

The product produced in accordance with the invention, namely a cured masticated rubber and plywood laminate has certain advantageous commercial/industrial applications, as are discussed below.

Commonly, standard plywood boards, such as 5 ply or 7 ply boards, are used as concrete form boards, creating the shape for concrete formations. The side of the plywood which faces the concrete needs to be oiled or it needs to have a releasing agent, such as a paper sheet disposed thereupon prior to pouring the concrete in order to facilitate the removal of the plywood from the concrete once set. Use of the cured masticated rubber and plywood laminate eliminates the need of a releasing agent or oiling, as the cured masticated rubber layer creates a barrier which allows removal of the boards fro the concrete. Furthermore, typically, a plywood form board without rubber is secured in place relative to the other forming boards by mechanical means such as nails or staples or the like. Retracting the nail once the concrete has set, may tend to cause damage to the concrete, whereas the masticated rubber layer, tends to seal any hole created by a nail or other mechanical fastening means.

Hardwood floor comprising adjacent planks of wood, mechanically secured to subflooring or support joists, is a common household flooring. A common problem with hardwood flooring is that overtime and with variations in humidity and moisture, adjacent planks tend to separate and/or increase in flexibility, leading to the common problem of squeaking floors. In accordance with the invention, a rubber wood laminate formed in accordance with the invention could be utilized as a subfloor, with the rubber layer facing downwardly, resting on support joists or subflooring. The positioning of the rubber layer below the wood layer causes a significant reduction in squeaking of the floor and acts as an acoustical insulation.

Certain prior art flooring includes a rubber sublayer and a wood layer which is laid on top. These layers are provided separately requiring time and energy to align and lay. The use of the product of the invention as a flooring, saves the time and effort of having to lay each layer separately. Furthermore, the flooring of the invention provides a low cost, effective acoustical control subfloor without required the need for separate realignment of the layers of flooring.

Other advantageous applications of the product of the invention are as a truck decking or as waterproof marine plywood.

There is also an environmental advantage to the use of a masticated rubber and wood product as masticated rubber is produced using a very high percentage of post industrial/consumer waste, thereby utilizing scrap material instead of disposing it.

The above description provides ample information for the person skilled in the art to practice the invention. Furthermore, it will be evident that modifications which are obvious to persons of ordinary skill in the art, may be made without departing from the spirit or scope of the invention, which is accordingly limited only by the claims appended hereto, purposively construed.

1. A wood and rubber composite sheet comprising a wood layer having a first surface and a layer of cured masticated rubber secured to said first surface.

2. The wood and rubber sheet as recited in claim 1 wherein adhesive material is disposed between said first surface and said rubber layer.

3. The wood and rubber sheet as recited in claim 2 wherein said adhesive material is Chemlock™ or Thixon™.

4. The wood and rubber sheet as recited in claim 1 wherein the rubber layer has a thickness in the range of 0.06 inches to 0.6 inches.

5. The wood and rubber sheet as recited in claim 1 wherein said rubber layer is comprised of Symar® rubber.

6. The wood and rubber sheet as recited in claim 1 wherein the wood layer is comprised of multiply plywood.

7. The wood and rubber sheet as recited in claim 6 wherein said plywood is five ply, ⅝^{th} inch thick plywood.

8. A method of manufacturing a composite wood and rubber sheet comprising the steps of:
(a) providing a layer of wood having an outer surface;
(b) providing a layer of uncured masticated rubber upon said outer surface,
(c) heating and pressing said layers together so as to cure and bond said rubber layer to said outer surface of wood.

9. The method of claim 1 comprising the further step of applying adhesive material to said outer surface prior to pressing said layers together.

10. The method of claim 9 wherein said adhesive is Chemlock™ or Thixon™.

11. The method of claim 9 wherein said layer of rubber is Symar® rubber.

12. The method of claim 9 wherein said rubber and wood layers are heated to a temperature of between 300 F and 345 F and are pressed under pressure of 200 to 400 psi.
